(19) United States
(12) Patent Application Publication
(10) Pub. No.: US 2023/0260038 A1
(43) Pub. Date: Aug. 17, 2023

(54) DIGITAL REPRESENTATION BASED ASSET EVALUATION AND SETTLEMENT ESTIMATION

(71) Applicant: INTERNATIONAL BUSINESS MACHINES CORPORATION, ARMONK, NY (US)

(72) Inventors: Muthu Sundaravadivel, Mayiladuthurai (IN); Hina Sharma, Pune (IN); Partho Ghosh, Kolkata (IN)

(21) Appl. No.: 17/650,887

(22) Filed: Feb. 14, 2022

(51) Int. Cl. G06Q 40/08; G06Q 10/10; G06F 30/20

(52) U.S. Cl. CPC G06Q 40/08; G06Q 10/10; G06F 30/20

(57) ABSTRACT

A method, computer system, and a computer program product for insuring an asset is provided. The present invention may include receiving a plurality of data for an asset. The present invention may include generating a digital representation for the based on the received plurality of data. The present invention may include simulating the digital representation in a plurality of conditions. The present invention may include generating an insurance policy for the asset based on the simulations of the digital representation in the plurality of conditions.

### BACKGROUND

The present invention relates generally to the field of computing, and more particularly to digital representations.

Manufacturers and/or other businesses may employ individuals who may work with physical assets within a physical ecosystem. The manufacturers and/or businesses may insure both the employees as well as the physical assets against at least, occupational injuries, product liabilities, and/or other accidents which may occur within the physical ecosystem. In the event of an accident one or more insurance companies may be involved in the assessment of the accident in order determine claim settlements and/or other matters related to the accident.

A virtual and/or smart inspection of a digital representation which may represent the physical asset and/or physical ecosystem in which the accident may have occurred may be utilized by insurance providers in better characterizing the accident and/or resolving claim settlements in a timely manner.

### SUMMARY

Embodiments of the present invention disclose a method, computer system, and a computer program product for digital representations. The present invention may include receiving a plurality of data for an asset. The present invention may include generating a digital representation for the based on the received plurality of data. The present invention may include simulating the digital representation in a plurality of conditions. The present invention may include generating an insurance policy for the asset based on the simulations of the digital representation in the plurality of conditions.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for asset insurance according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for asset insurance. As such, the present embodiment has the capacity to improve the technical field of digital twins and smart contract agreements by enabling a tamper proof data exchange and insurance policy agreements between multiple parties. More specifically, the present invention may include receiving data for an asset, generating a digital representation for the asset based on the data received, simulating the digital representation in a plurality of conditions, and generating an insurance policy for the asset based on the simulations of the digital representation in the plurality of conditions.

As described previously, manufacturers and/or other businesses may employ individuals who may work with physical assets within a physical ecosystem. The manufacturers and/or businesses may insure both the employees as well as the physical assets against at least, occupational injuries, product liabilities, and/or other accidents which may occur within the physical ecosystem. In the event of an accident one or more insurance companies may be involved in the assessment of the accident in order determine claim settlements and/or other matters related to the accident.

A virtual and/or smart inspection of a digital representation which may represent the physical asset and/or physical ecosystem in which the accident may have occurred may be utilized by insurance providers in better characterizing the accident and/or resolving claim settlements in a timely manner.

Therefore, it may be advantageous to, among other things, receive data for an asset, generate a digital representation for the asset based on the data received, simulate the digital representation in a plurality of conditions, and generate an insurance policy for the asset based on the simulations of the digital representation in the plurality of conditions.

According to at least one embodiment, the present invention may improve safety of individuals associated with an asset being insured by providing one or more recommendations based on simulations performed utilizing real time data received from at least IoT devices associated with the asset. The one or more recommendations may include at least part replacement reminders, maintenance reminders, safety alerts, insurance policy reminders, amongst other recommendations.

According to at least one embodiment, the present invention may improve trust between parties of an insurance agreement by storing data associated with an asset being insured on a distributed ledger, the distributed ledger being accessible to all parties of the insurance agreement through an asset insurance user interface.

According to at least one embodiment, the present invention may improve the efficacy of insurance policy agreements by embedding one or more smart contracts in an insurance policy agreement and automatically fulfilling the terms of the smart contract based on real time data received.

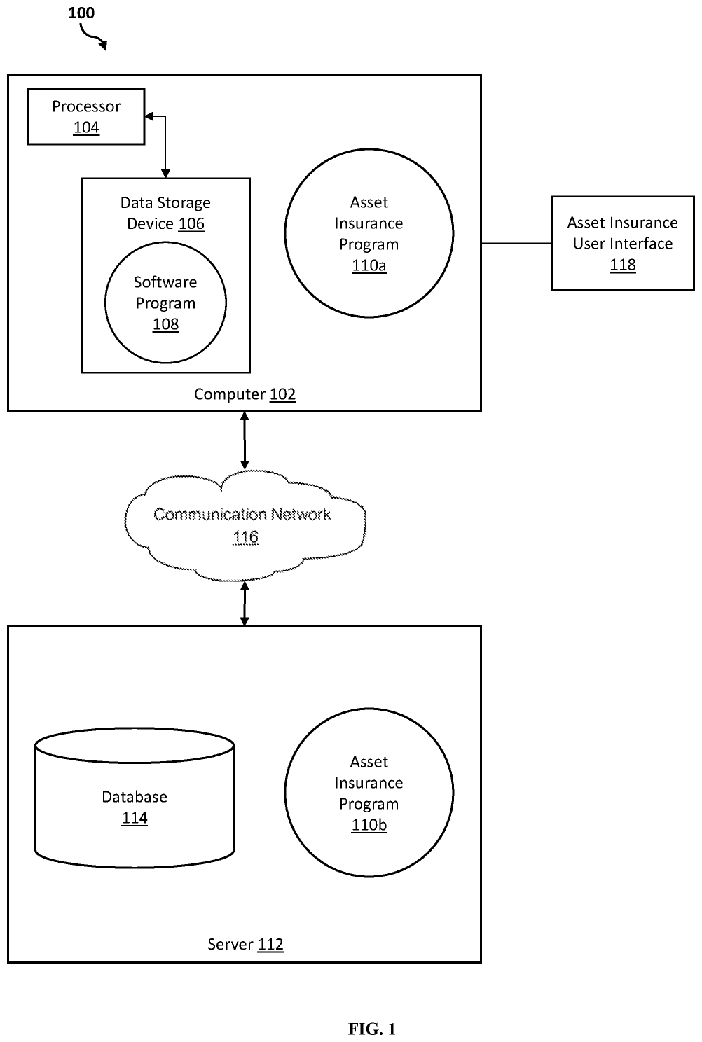

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an asset insurance program 110a. The networked computer environment 100 may also include a server 112 that is enabled to run an asset insurance program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

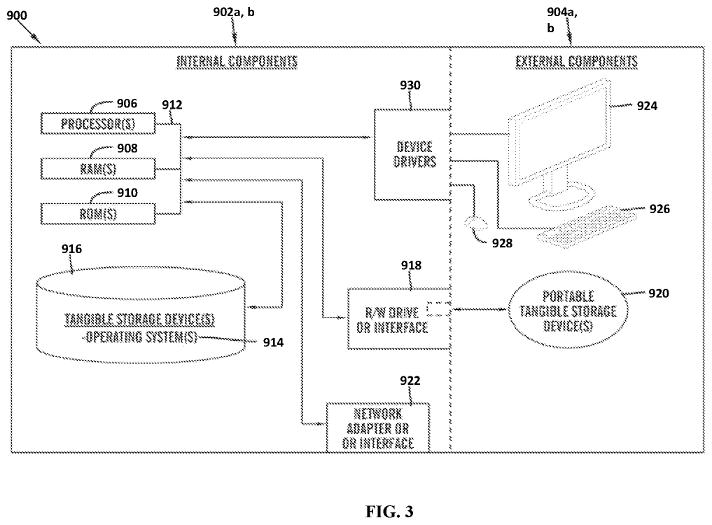

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the asset insurance program 110a, 110b may interact with a database 114 that may be embedded in various storage devices, such as, but not limited to a computer/mobile device 102, a networked server 112, or a cloud storage service.

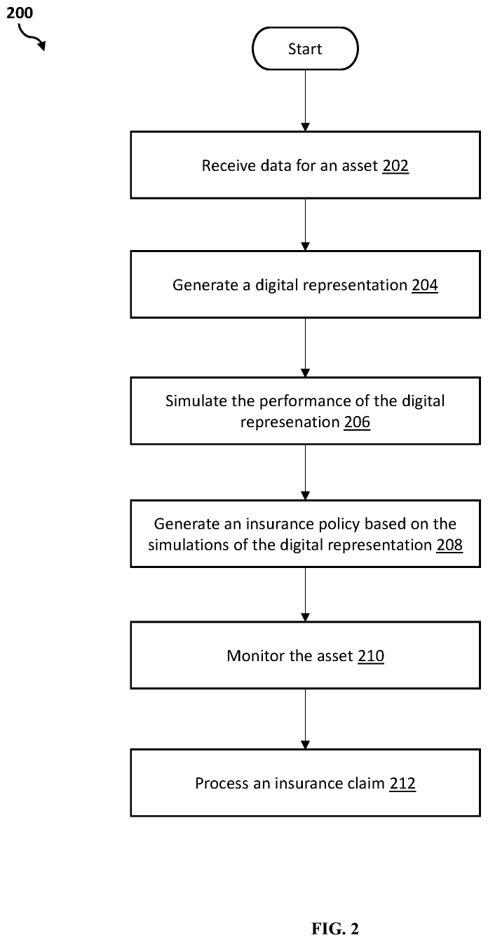

According to the present embodiment, a user using a client computer 102 or a server computer 112 may use the asset insurance program 110a, 110b (respectively) to enable tamper proof data exchange and insurance policy agreements between multiple parties. The asset insurance method is explained in more detail below with respect to FIG. 2.

Referring now to FIG. 2, an operational flowchart illustrating the exemplary asset insurance process 200 used by the asset insurance program 110a and 110b (hereinafter asset insurance program 110) according to at least one embodiment is depicted.

At 202, the asset insurance program 110 receives data for an asset of interest. The asset of interest may be a physical asset and/or physical ecosystem, such as, but not limited to, a motor vehicle, consumer product, medication, vaccination, manufacturing equipment, factory, office building, retail store, warehouse, storage facility, and/or other physical asset and/or physical ecosystem which may be insured. The asset of interest may be identified by a user in an asset insurance user interface 118.

The asset insurance program 110 may receive and/or access data with respect to the asset of interest identified by the user in the asset insurance user interface 118 from at least, the user, documents uploaded by the user, one or more Internet of Things (IoT) devices associated with the asset, images and/or 3D scans of the asset, smart wearable data from the operators of the asset, and/or one or more publicly available resources, amongst other methods of receiving and/or accessing data. The asset insurance program 110 may store the data received and/or accessed with respect to the asset in a knowledge corpus (e.g., database 114).

The knowledge corpus (e.g., database 114) may be a distributed ledger (e.g., blockchain, shared ledger). The distributed ledger may be accessed by and/or viewable in the asset user interface 118 by all parties of an insurance agreement. The asset insurance user interface 118 may be displayed by the asset insurance program 110 in at least an internet browser, dedicated software application, and/or as an integration with a third party software application. The asset insurance program 110 may continuously add data to the knowledge corpus (e.g., database 114) as it is received from at least the one or more IoT devices and/or other sources of data associated with the asset of interest.

In an embodiment in which the asset of interest may be a physical ecosystem, the user may be provide data such as, but not limited to, square footage, property size, location, material used in construction, window types, year built, blueprints, roofing details, architecture, information on appliances, occupancy, ventilation systems, airflow details, as well as additional data from one or more IoT devices associated with the physical ecosystem. The one or more IoT devices associated with the physical ecosystem may include, but are not limited to including, thermostats, lighting, air quality, smoke detectors, carbon monoxide detectors, irrigations systems, security, air conditioning, movement, and ventilation systems, amongst other IoT devices. The one or more IoT devices may perform readings of the environment within the physical ecosystem. The IoT devices may be connected to one or more sensors (e.g., temperature sensors, motion sensors, humidity sensors, pressure sensors, accelerometers, gas sensors, multi-purpose IoT sensors, amongst other sensors) to perform the one or more readings. The data from the one or more readings performed by the IoT devices may be stored on the IoT device itself and/or broadcasted to the knowledge corpus (e.g., database 114). The asset insurance program 110 may also receive images and/or 3D scans of assets comprising the physical ecosystem, such as, but not limited to, machines and/or equipment, amongst other assets. The asset insurance program 110 may receive the images, videos, and/or 3D scans from an IoT device equipped with a camera. The asset insurance program 110 may utilize a computer-aided design (CAD) package amongst other photogrammetry software in processing digital data received from the IoT device. As will be explained in more detail below, this data may be utilized by the asset insurance program 110 in generating a digital representation of the physical ecosystem and/or the assets comprising the physical ecosystem. The asset insurance program 110 may also receive data from one or more smart wearable devices which may be worn by one or more operators of the assets comprising the physical ecosystem. All data received by the asset insurance program 110 including data received from the one or more smart wearable devices shall not be construed as to violate or encourage the violation of any local, state, federal, or international law with respect to privacy protection. The asset insurance program 110 may require consent from any individual for which data will be received and/or require consent on behalf of the individual from the user, if sufficient to satisfy and local, state, federal, and/or international laws.

In an embodiment in which the asset of interest is a motor vehicle such as a car, the user may provide data and/or the asset insurance program may access data such as, but not limited to, product configuration, materials used, manufacturing/process parameters, service history, diagnostics data, vehicle modifications, odometer readings, telematics data, recall campaigns, product details, accident reports, amongst other data which may be stored in the knowledge corpus (e.g., database 114). The asset insurance program 110 may also receive additional data from one or more IoT devices associated with the motor vehicle which may be stored in the knowledge corpus (e.g., database 114). As will be explained in more detail below, the real time data received from the one or more IoT devices associated with the asset of interest may be utilized in generating a digital representation and/or simulating a performance of the digital representation.

Additionally, the asset insurance program 110 may receive data from the user utilized in running and/or operating the asset of interest. Data utilized in running and/or operating the asset of interest may include, but is not limited to including, procedures, checklists, equipment information, operating instructions, training plans, skills assessments, instructional videos, diagrams, business processes, amongst other data. As will be explained in more detail below with respect to step 204, data received from the user utilized in running and/or operating the asset of interest as well as other data stored in the knowledge corpus (e.g., database 114) may be utilized in generating a digital triplet. The digital triplet may be an extension of a digital twin representing the human knowledge utilized in running and/or operating the asset of interest.

At 204, the asset insurance program 110 generates a digital representation of the asset of interest for which the data may be received. The digital representation may be a digital twin and/or digital triple. A digital twin may be a digital representation of at least an object, entity and/or system that spans the object, entity, and/or system's lifecycle. The digital twin may be updated using real time data, and may utilize, at least, simulation, machine learning, and/or reasoning in aiding informed decision making. A digital triplet may be an extension of the digital twin which may represent the human knowledge utilized in running the object, entity, and/or system represented by the digital twin. The digital triplet may be generated utilizing at least the data stored in the knowledge corpus (e.g., database 114) related to the running and/or operating of the asset of interest.

The asset insurance program 110 may generate the digital representation for the asset of interest based on the data received at step 202 and/or data stored in the knowledge corpus (e.g., database 114). The digital representation may be updated in real time based on at least data received from the one or more IoT devices, smart wearable devices, and/or any other additional data received with the asset of interest. The asset insurance program 110 may update at least the health of the asset and/or the health of components comprising the asset based on the additional data received.

For example, an asset of interest such may be a machine on a factory floor. The asset insurance program 110 may generate the digital representation for the machine based on details provided by a user in the asset insurance user interface 118, such as, but not limited to, a brand, model number, bill of materials, product codes, part numbers, design specifications, production processes, engineering information, material composition of parts, amongst other data for the machine. The asset insurance program 110 may also receive additional real time data from one or more IoT devices associated with the machine. The data may include, but is not limited to including, maintenance/upkeep, operating conditions, health of the machine and/or machine components, hours the machine is utilized per day, usage patterns, structural health, amongst other IoT device/sensor based analytic data. The asset insurance program 110 may utilize the analytic data to update the digital representation of the machine such that the digital representation may accurately represent the machine on the factory floor.

At 206, the asset insurance program 110 simulates the performance of the digital representation. The asset insurance program 110 may simulate the performance of the digital representation in a plurality of conditions based on at least the data stored in the knowledge corpus (e.g., database 114). The asset insurance program 110 may utilize one or more machine learning models in simulating the performance of the digital representation in the plurality of conditions. The one or more machine learning models may include, but are not limited to including, Generative Adversarial Networks (GANs) Convolutional Neural Networks (CNNs), Artificial Neural Networks (ANNs), Support Vector Machine (SVM), K-Nearest Neighbors (KNN), Naïve Bayes, and/or a hybrid model. The hybrid model may be trained to combine the predictions of two or more machine learning models.

The asset insurance program 110 may determine the conditions in which the digital representation may be simulated based on at least the data stored in the knowledge corpus (e.g., database 114) and/or IoT data received for the asset of interest. The asset of interest may also incorporate an asset health monitoring (AHM) system in which additional data related to at least humidity, geospatial, and/or weather conditions may be stored in the knowledge corpus (e.g., database 114) and incorporated into the conditions determined by the asset insurance program 110. The conditions in which the digital representation may be simulated may be adjusted to account for at least errors and/or lack of data received with respect to the asset of interest such that the asset insurance program 110 may identify possible risks.

For example, User 1 purchases a brand new Machine X to be insured through the asset insurance program 110. User 1 may identify the brand, model number, bill of materials, and other data for Machine X in the asset insurance user interface 118. The asset insurance program 110 may source additional data from publicly available resources based on the data provided by User 1 in the asset insurance user interface 118 and generate a digital representation of User 1's Machine X. User 2 may also purchase a brand new Machine X to be insured through the asset insurance program 110. User 2 may provide the same brand, model number, bill of materials, and other data for Machine X in the asset insurance user interface 118. Accordingly, the asset insurance program 110 may source the same additional data for User 2's Machine X and generate the digital representation of User 2's Machine X. User 1 and User 2's Machine X digital representation may be indistinguishable. As additional data is received from User 1's Machine X and User 2's Machine X the asset insurance program 110 may adjust the plurality of conditions in which each digital representation is simulated. The asset insurance program 110 may receive data from IoT devices associated with User 1's Machine X showing the machine is utilized 12 hours a day in a high humidity environment. In contrast, the asset insurance program 110 may receive data from the IoT devices associated with User 2's Machine X showing the machine is utilized 4 hours a day in a low humidity environment. Accordingly, the asset insurance program 110 may adjust the conditions under which it simulates User 1's Machine X and User 2's Machine X to represent the actual use of the machine more accurately.

At 208, the asset insurance program 110 generates an insurance policy based on the simulations of the digital representation for the plurality of conditions. The generated insurance policy may further be based on guidance and directive from an insurer (e.g., based on templates and/or mandatory inclusions, among other things which may be directed by an insurer). The insurance policy may include, but is not limited to including, policy premium amount, exemptions, causation, damage profiles, incentives, amongst other terms. The terms of the insurance policy may be agreed upon between the user and the insurer within the asset insurance user interface 118. The terms of the agreement may be stored on the distributed ledger (e.g., blockchain, shared ledger) of the knowledge corpus (e.g., database 114).

The insurance policy may include one or more smart contracts between the user and the insurance company. A smart contract may be a program stored on a blockchain that executes upon fulfillment of predetermined conditions. For example, the asset insurance program 110 may attach incentives to safe practices in operating the asset of interest such as a vehicle in exchange for a reduced rate and/or liability in the event the user submits a claim. The smart contract may be stored on the distributed ledger (e.g., blockchain, shared ledger) of the knowledge corpus (e.g., database 114) and executed based on data received from at least the one or more IoT devices associated with the asset of interest. In this example, the asset insurance program 110 may generate a smart contract offering the user a $15 dollar premium off the user's insurance policy for the next month if the user does not exceed 80 miles per hour. The asset insurance program 110 may monitor the speed of the car using the one or more IoT devices associated with the car, and at the end of the month, the smart contract may automatically be executed, and the user's account credited for $15 dollars for not exceeding 80 miles per hour.

The asset insurance program 110 may also enable lower rates based on the amount of data provided by the user (e.g., insured). The asset insurance program 110 may only enable lower rates and/or other policy adjustment offers to the user (e.g., insured) within the parameters set by the insurer and/or upon receiving approval of a proposed policy adjustment from the insurer. The insurer mays set the parameters by which the asset insurance program 110 may generate policy adjustments within the asset insurance user interface 118. For example, a medication may need to be stored below a certain temperature in order to maintain efficacy. The asset insurance program 110 may generate an insurance policy with a lower premium value for a user with IoT devices that monitor the temperature of storage and/or transport of the medication as compared to a user without IoT devices monitoring the temperature of storage and/or transport.

At 210, the asset insurance program 110 monitors the asset of interest. The asset insurance program 110 may monitor the asset of interest based on at least data received. The data received which may be utilized in monitoring the asset of interest may include, but is not limited to including, data from the one or more IoT devices, images and/or 3D scans of the asset, smart wearable data from an operator of the asset, data received from the user in the asset insurance user interface 118, amongst other real time data and/or additional data which may be utilized in updating the digital representation and/or the conditions.

The asset insurance program 110 may provide one or more recommendations to the user based on additional data received in monitoring the asset. The asset insurance program 110 may monitor the asset of interest by continuously simulating the performance of the digital representation based on the additional data received using the machine learning models detailed above with respect to step 206. The asset insurance program 110 may also leverage one or more pattern recognition techniques in identifying similar simulations and/or outcomes stored in the knowledge corpus (e.g., database 114) to provide the one or more recommendations to the user. The asset insurance program 110 may provide recommendations to the user when the performance simulated for the digital representation based on the additional data results in an outcome above a threshold. The simulation results may be a numerical value determined by the asset insurance program 110 based on the probability of one or more outcomes. The numerical value of the simulation results may be greater for simulations in which safety of the user (e.g., insured) is in danger as compared to simulations for maintenance reminders. The threshold may be a predetermined threshold set by either the user and/or insurance company as part of the insurance policy within the asset insurance user interface 118. The threshold may also be determined by the asset insurance program based on the severity of the outcome resulting from the simulation.

The recommendations may include, but are not limited to including, part replacement reminders, maintenance reminders, safety alerts, insurance policy reminders, amongst other recommendations. The asset insurance program 110 may provide the recommendations to the user in the asset insurance user interface 118, to a smart phone and/or other device associated with the user as a notification, text message, email, and/or another alert. The asset insurance program 110 may transmit recommendations to the user based on the severity of the outcome resulting from the simulation. The asset insurance program 110 may store all records of recommendations to the user in the knowledge corpus (e.g., database 114), as will be explained in more detail below, the records stored in the knowledge corpus (e.g., database 114) may be utilized in determining causation, liability, and/or claim settlement amounts.

For example, if the insurance policy agreement includes a smart contract which directs that the user may receive a $15 dollar premium off the user's insurance policy for the next month if the user does not exceed 80 miles per hour in their car, then the asset insurance program 110 may provide a recommendation and/or alert to the driver if the vehicle exceeds 75 miles per hour. The speed of the car may be monitored by the asset insurance program 110 using one or more IoT devices associated with the car.

At 212, the asset insurance program 110 processes an insurance claim. The asset insurance program 110 may receive an insurance claim from the user in the asset insurance user interface 118. The insurance claim may include, but is not limited to including, details with respect to the asset of interest, such as malfunctions, damages, and/or causes, amongst other details.

The asset insurance program 110 may request additional details from the user in the form of prompts prior to processing the insurance claim. Additional details requested by the asset insurance program 110 may include, but are not limited to including, images of the asset and/or asset components, database logs, environmental conditions, amongst other data. The asset insurance program 110 may utilize at least the details provided by the user in the asset insurance user interface 118 to simulate the performance of the digital representation to the outcome of the insurance claim. The asset insurance program 110 may provide the results of the simulations in the asset insurance user interface 118.

The results displayed by the asset insurance program 110 in the asset insurance user interface 118 may include details as to different factors which may have caused the outcome and the number of simulations in which each factor resulted in the outcome. The asset insurance program 110 may utilize the simulations to provide liability estimates which may be accepted and/or rejected by each party of the insurance policy agreement in the asset insurance user interface 118. The asset insurance program 110 may utilize the accepted and/or rejected terms of proposed settlements in preparing future liability estimates in addition to guidance and directive from an insurer (e.g., based on templates and/or mandatory inclusions, among other things which may be directed by an insurer).

In an embodiment, the asset insurance program 110 may utilize Augmented Reality (AR) and/or Virtual Reality (VR) in providing a visual display of the simulations which resulted in the outcome leading to the insurance claim. The visual display may be presented utilizing AR, VR, and/or within the asset insurance user interface 118. The visual display may include details as to different factors such as, speed of a vehicle, human interactions, simulated weather conditions based on the time and location of the event, damage profiling, amongst other details. The asset insurance program 110 may utilize smart glasses, smart headsets, smart phones, and/or other AR or VR compatible devices in displaying the simulations which resulted in the outcome to the user.

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the asset insurance program 110a in client computer 102, and the asset insurance program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the asset insurance program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the asset insurance program 110a in client computer 102 and the asset insurance program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the asset insurance program 110a in client computer 102 and the asset insurance program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

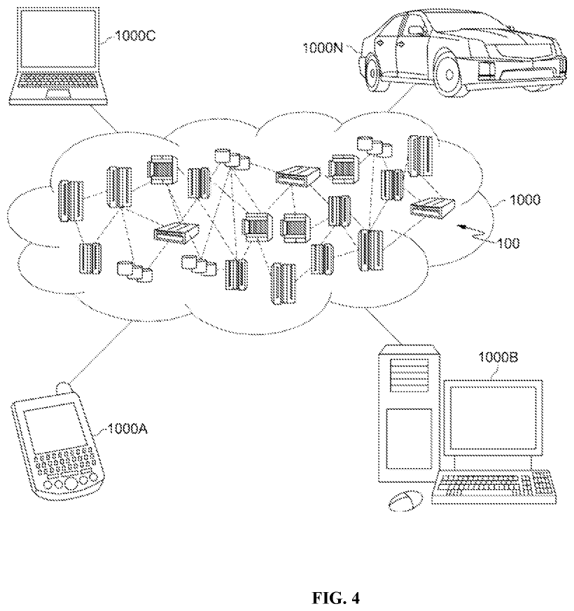

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

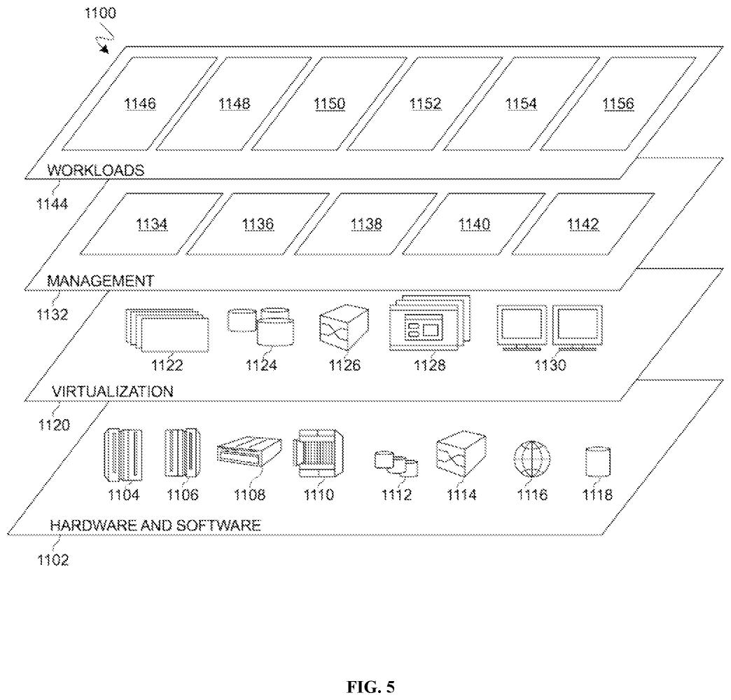

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and asset insurance program 1156. An asset insurance program 110a, 110b provides a way to enable tamper proof data exchange and insurance policy agreements between multiple parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

1. A method for insuring assets, the method comprising:
receiving a plurality of data relating to an asset from one or more Internet of Things (IoT) devices, wherein the plurality of data is stored in a knowledge corpus and includes at least data for operating the asset;
generating a digital representation for the asset based on the received plurality of data wherein the digital representation is a digital triplet, wherein the digital triplet is an extension of a digital twin incorporating the data for operating the asset;
simulating the digital representation in a plurality of conditions utilizing an output of one or more machine learning models, wherein the plurality of conditions are determined based on at least the data received from the one or more IoT devices associated with the asset; and
generating one or more terms of an insurance policy for the asset based on potential risks identified during the simulations of the digital representation in the plurality of conditions.

2. The method of claim 1, wherein the plurality of conditions are determined based on at least a portion of the plurality of data received from the one or more IoT devices associated with the asset.

3. The method of claim 1, wherein the one or more terms of the insurance policy are adjusted based on the potential risks identified during the simulations of the digital representation, wherein the insurance policy is comprised of one or more smart contracts stored in the knowledge corpus, wherein the knowledge corpus is a distributed ledger.

4. The method of claim 3, further comprising:
receiving data from the one or more IoT devices associated with the asset;
determining that at least one term of at least one of the one or more smart contracts of the insurance policy have been fulfilled; and
executing the at least one smart contract of the insurance policy in which the terms have been fulfilled.

5. The method of claim 1, further comprising:
receiving an insurance claim from a user for the asset;
simulating an outcome for the asset using the output of the one or more machine learning models based on details provided in the insurance claim from the user; and
providing results from simulating the outcome for the asset in an asset insurance user interface.

6. (canceled)

7. The method of claim 1, further comprising:
receiving additional data from the one or more IoT devices associated with the asset and an asset health monitoring system associated with the asset;
updating the digital representation and the plurality of conditions, wherein an updated digital representation of the asset accurately represents a current state of the asset and an updated plurality of conditions accurately represents current conditions in which the asset is being operated;
simulating the updated digital representation in the updated plurality of conditions using the output of the one or more machine learning models; and
providing one or more recommendations to a user of the asset based on the simulation of the updated digital representation.

8. A computer system for insuring assets, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a plurality of data relating to an asset from one or more Internet of Things (IoT) devices, wherein the plurality of data is stored in a knowledge corpus and includes at least data for operating the asset;
generating a digital representation for the asset based on the received plurality of data, wherein the digital representation is a digital triplet, wherein the digital triplet is an extension of a digital twin incorporating the data for operating the asset;
simulating the digital representation in a plurality of conditions utilizing an output of one or more machine learning models, wherein the plurality of conditions are determined based on at least the data received from the one or more IoT devices associated with the asset; and
generating one or more terms of an insurance policy for the asset based on potential risks identified during the simulations of the digital representation in the plurality of conditions.

9. The computer system of claim 8, wherein the plurality of conditions are determined based on at least a portion of the plurality of data received from the one or more IoT devices associated with the asset.

10. The computer system of claim 8, wherein the one or more terms of the insurance policy are adjusted based on the potential risks identified during the simulations of the digital representation, wherein the insurance policy is comprised of one or more smart contracts stored in the knowledge corpus, wherein the knowledge corpus is a distributed ledger.

11. The computer system of claim 10, further comprising:
receiving data from the one or more IoT devices associated with the asset;
determining that at least one term of at least one of the one or more smart contracts of the insurance policy have been fulfilled; and
executing the at least one smart contract of the insurance policy in which the terms have been fulfilled.

12. The computer system of claim 8, further comprising:
receiving an insurance claim from a user for the asset;
simulating an outcome for the asset using the output of the one or more machine learning models based on details provided in the insurance claim from the user; and
providing results from simulating the outcome for the asset in an asset insurance user interface.

13. (canceled)

14. The computer system of claim 8, further comprising:
receiving additional data from the one or more IoT devices associated with the asset and an asset health monitoring system associated with the asset;
updating the digital representation and the plurality of conditions, wherein an updated digital representation of the asset accurately represents a current state of the asset and an updated plurality of conditions accurately represents current conditions in which the asset is being operated;
simulating the updated digital representation in the updated plurality of conditions using the output of the one or more machine learning models; and
providing one or more recommendations to a user of the asset based on the simulation of the updated digital representation.

15. A computer program product for insuring assets, comprising:
one or more non-transitory computer-readable storage media and program instructions stored on at least one of the one or more tangible storage media, the program instructions executable by a processor to cause the processor to perform a method comprising:
receiving a plurality of data relating to an asset from one or more Internet of Things (IoT) devices, wherein the plurality of data is stored in a knowledge corpus and includes at least data for operating the asset;
generating a digital representation for the asset based on the received plurality of data, wherein the digital representation is a digital triplet, wherein the digital triplet is an extension of a digital twin incorporating the data for operating the asset;
simulating the digital representation in a plurality of conditions utilizing an output of one or more machine learning models, wherein the plurality of conditions are determined based on at least the data received from the one or more IoT devices associated with the asset; and
generating one or more terms of an insurance policy for the asset based on potential risks identified during the simulations of the digital representation in the plurality of conditions.

16. The computer program product of claim 15, wherein the plurality of conditions are determined based on at least a portion of the plurality of data received from the one or more IoT devices associated with the asset.

17. The computer program product of claim 15, wherein the one or more terms of the insurance policy are adjusted based on the potential risks identified during the simulations of the digital representation, wherein the insurance policy is comprised of one or more smart contracts stored in the knowledge corpus, wherein the knowledge corpus is a distributed ledger.

18. The computer program product of claim 17, further comprising:
receiving data from the one or more IoT devices associated with the asset;
determining that at least one term of at least one of the one or more smart contracts of the insurance policy have been fulfilled; and
executing the at least one smart contract of the insurance policy in which the terms have been fulfilled.

19. The computer program product of claim 15, further comprising:
receiving an insurance claim from a user for the asset;
simulating an outcome for the asset using the output of the one or more machine learning models based on details provided in the insurance claim from the user; and
providing results from simulating the outcome for the asset in an asset insurance user interface.

20. The computer program product of claim 15, further comprising:
receiving additional data from the one or more IoT devices associated with the asset and an asset health monitoring system associated with the asset;
updating the digital representation and the plurality of conditions, wherein an updated digital representation of the asset accurately represents a current state of the asset and an updated plurality of conditions accurately represents current conditions in which the asset is being operated;
simulating the updated digital representation in the updated plurality of conditions using the output of the one or more machine learning models; and
providing one or more recommendations to a user of the asset based on the simulation of the updated digital representation.

21. The method of claim 1, further comprising:
monitoring the asset based on additional data received, wherein the additional data received is utilized as input for the one or more machine learning models, and wherein the output of the one or more machine learning models is utilized in continuously simulating a performance of the digital representation; and
providing one or more recommendations to a user based on one or more similar simulations identified within the knowledge corpus using one or more pattern recognition techniques.
